(19) United States
(12) Patent Application Publication
(10) Pub. No.: US 2014/0027320 A1
(43) Pub. Date: Jan. 30, 2014

(54) CONVERTIBLE CANDLE HOLDER AND SERVING PLATE ASSEMBLY

(71) Applicant: Desiree Norris, Miramar, FL (US)

(72) Inventor: Desiree Norris, Miramar, FL (US)

(21) Appl. No.: 13/946,754

(22) Filed: Jul. 19, 2013

Related U.S. Application Data
(60) Provisional application No. 61/676,200, filed on Jul. 26, 2012.

(51) Int. Cl. A45C 11/00; F21V 35/00

(52) U.S. Cl. CPC A45C 11/00; F21V 35/00
USPC 206/216

(57) ABSTRACT

A combination dessert plate having a seal for attaching to a variety of candle holders is disclosed. Combining the two items you have a candle holder that transforms into a base section of a combination dessert plate. The plate may be generally placed on the top portion of a candle holder. The combination dessert plate can be used in decorating weddings, all types of parties, home decor, store and restaurant displays.

### PRIORITY CLAIM

This application claims priority, and incorporates by reference in its entirety, to Provisional Application No. 61/676,200, filed on Jul. 23, 2012.

### BACKGROUND OF THE INVENTION

Candle holders provide a means of holding a candle in place during events, such as dinner parties and formal dinners. However, the unique designs and features of candle holders are rather limited in that candle holders are utilized in very limited circumstances. Similarly true dessert plates are typically placed on a table or credenza to display various desserts and treats. However, the dessert platter is typically set on the surface of the table or elevated on boxes or pedestals. Each of the individual aforementioned items are classically utilized in unique, but separate circumstances.

### SUMMARY OF THE INVENTION

In one example embodiment, a combination dessert plate includes a plate having a bottom portion and a seal disposed upon said bottom portion comprising at least one inner edge and an outer edge. The plate assembly further includes a candle holder, wherein a portion of said candle holder is positioned adjacent at least one inner edge and wherein said seal is capable of releaseably engaging said candle holder when said plate is disposed thereon.

In another example embodiment, a method of using a bias lock mechanism is disclosed that includes the steps of disposing a candle holder on a surface, wherein said candle holder having a top edge that includes a portion for receiving a candle. The method further includes the step of positioning a plate over said candle holder, wherein said plate having a bottom portion with a seal attached thereon, wherein said seal having an inner edge and an outer edge, and disposing said plate on said top edge of said candle holder.

### BRIEF DESCRIPTION OF THE DRAWINGS

The invention will be further explained with reference to the appended Figures, wherein like structure is referred to by like numerals through the several views, and wherein:

FIG. 1 illustrates a bottom plan view of a convertible plate assembly.

FIG. 2 describes a top perspective view of a convertible plate/candle holder assembly.

FIG. 3 describes another embodiment of a plate assembly.

FIG. 4 describes another example embodiment of a candle holder assembly.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

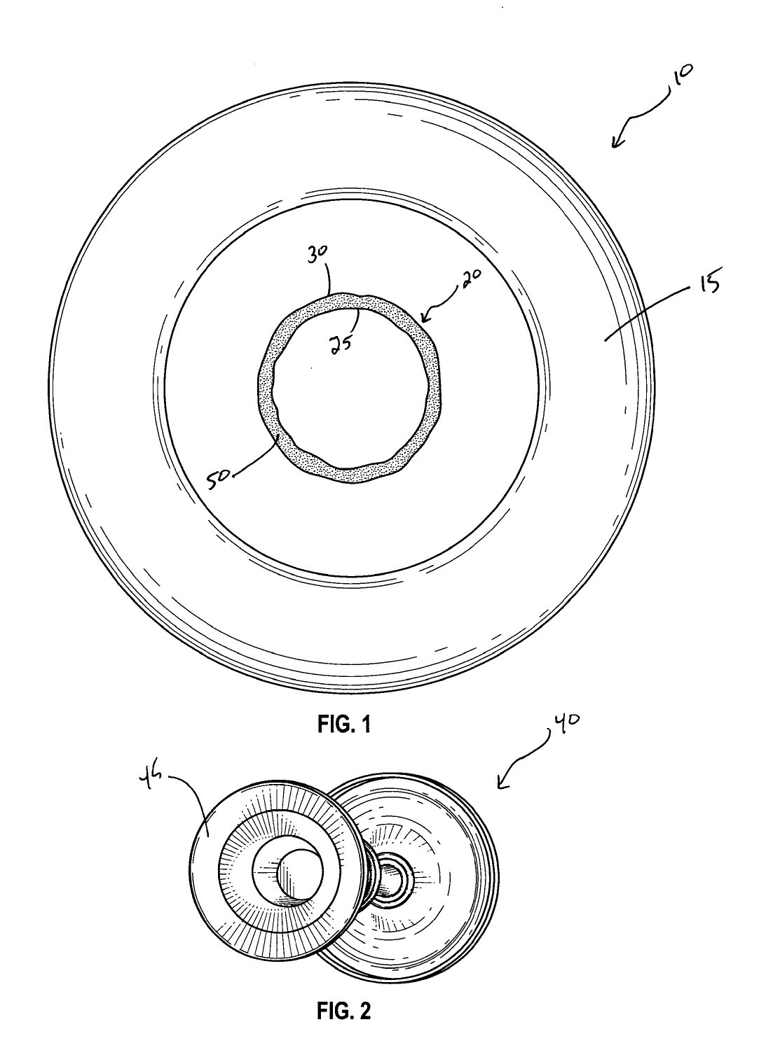

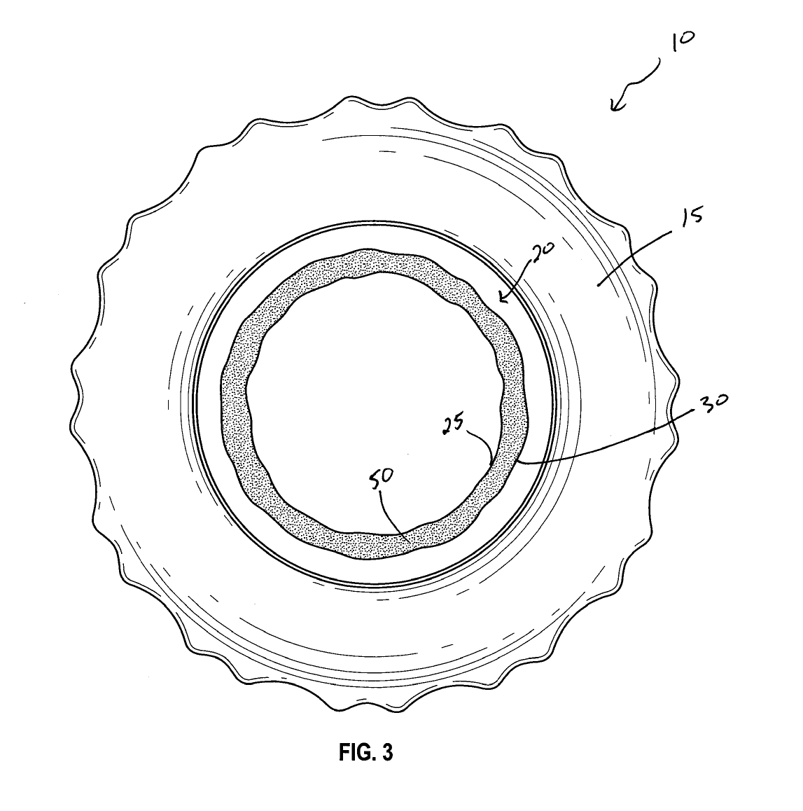

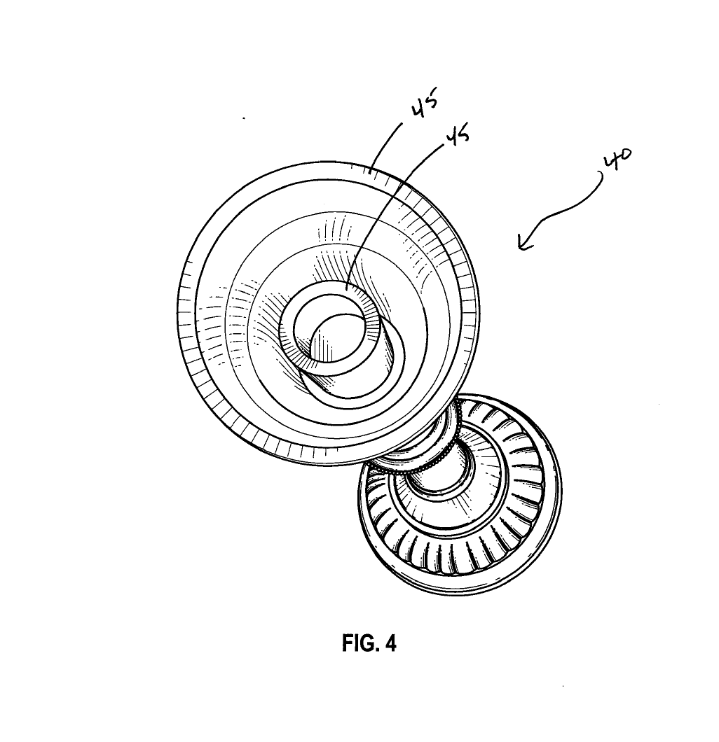

Combining the two items you have a candle holder that transforms into a base for a dessert plate. The plate may be generally placed on the top portion of a candle holder. Referring now to FIGS. 1 and 3, plate 10 generally includes a bottom portion 15 and a seal 20 disposed thereon. Seal 20 may be made of a number of materials. In one example embodiment, as shown in FIGS. 1 and 3, seal 20 is fashioned with an inner edge 25 and an outer edge 30. Each of the aforementioned edges are shown with an irregular or non-symmetrical surface.

In at least these example embodiments, the inner edge 25 will provide securement to the candleholder. In an alternative related embodiment, the seal may include symmetrical edges. Although not wanting to be bound by any particular theory the bottom surface 50 of seal 20 will be generally level to prevent a serving dishing from rocking when placed on a surface.

It should be appreciated that seal 20 may be permanently disposed on bottom portion 15. In an alternative embodiment, seal 20 may be removeably disposed on bottom portion 15. In an embodiment where seal 20 is permanently fixed, the fixation means could be a number of processes known by one of ordinary skill in the art. Some nonexclusive examples of attachment include chemical welding, adhesives, fasteners, or mechanical integration.

Seal 20 is structured in a manner to allow the top edge 45 of candle holder 40, as shown in FIGS. 2 and 4, to securely connect with bottom portion 15 and inner edge 25 of seal, as shown in FIGS. 1 and 3. This functionality provides one with the ability to conveniently attach a plate to a candle holder for use to display and/or serve a variety of desserts, treats, and related foodstuffs.

Plate 10 and candle holder 40 are individually functional, but together they create new versatile piece, thereby expanding one's display capabilities for dinner parties, gatherings and the like. When in use candle holder 40 will be positioned in an upright manner to provide a base to attached plate 10 thereon. When plate 10 is positioned over candle holder 40, seal 20 is removeably coupled to plate 10 to candle holder 40.

Although seal will be fairly rigid to provide a sufficient amount of securement to withstand the weight associated with a plate having foodstuffs thereon, the securement is not so robust as to require an excessive amount of force to remove plate 10 from candle holder 40 when the combination is no longer desired. The sealing mechanism could be a number of features, such as intrinsic material rigidity, a spring bias mechanism, or turn-knob locking mechanism. Another connection means may comprise seal 20 with a turn connector, similar to opening and closing a bottle or removing a gas cap.

Various embodiments of the dessert plate assembly described herein can be used in decorating weddings, all types of parties, home decor, store and restaurant displays. Candle holder can be used as a regular candlestick holder as decorating the home, parties, wedding decor, store displays, etc. After attaching the two items, it then adds personality to anything that is placed on the dessert plate. The candle holder provides style and the height gives it a presence along with the beautiful accompanying plate. Together they can be used on dining tables, buffet displays, entertainment centers, table centerpieces, displaying desserts, bakery shops and restaurants.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. A combination dessert plate comprising:
a plate having a bottom portion;
a seal disposed upon said bottom portion comprising at least one inner edge and an outer edge; and
a candle holder, wherein a portion of said candle holder is positioned adjacent at least one inner edge and wherein said seal is capable of releasably engaging said candle holder when said plate is disposed thereon.

2. The combination dessert plate of claim 1 wherein said seal is permanently fixed to said bottom portion.

3. The combination dessert plate of claim 1 wherein said seal is removeably disposed to said bottom portion.

4. The combination dessert plate of claim 2 wherein said seal is disposed to said bottom portion by an attachment means selected from a group consisting of chemical welding, adhesives, fasteners, or mechanical integration.

5. The combination dessert plate of claim 1 wherein said seal comprises a spring bias mechanism.

6. The combination dessert plate of claim 1 wherein said at least one inner portion and said outer portion are asymmetrically shaped.

7. The combination dessert plate of claim 1 wherein said at least one inner portion is asymmetrically shaped.

8. The combination dessert plate of claim 1 wherein said at least one inner portion and said outer portion are symmetrically shaped.

9. The combination dessert plate of claim 1 wherein said at least one inner portion is symmetrically shaped.

10. The combination dessert plate of claim 1 wherein said at least one inner portion and said outer portion is symmetrically shaped.

11. A method of using a bias lock mechanism the steps comprising:
disposing a candle holder on a surface, wherein said candle holder having a top edge that includes a portion for receiving a candle;
positioning a plate over said candle holder, wherein said plate having a bottom portion with a seal attached thereon, wherein said seal having an inner edge and an outer edge; and
disposing said plate on said top edge of said candle holder.

12. The method of claim 11, wherein disposing said plate on said top edge connects said candle holder to said inner edge of said seal.

13. The method of claim 12, wherein said seal having a spring bias connects said inner edge to said candle holder.

14. The method of claim 12, further comprising removing said plate from said candle holder.

15. The method of claim 11, further comprising removing said plate from said candle holder.

16. The method of claim 11, wherein said seal being removeably disposed on said plate.

17. The method of claim 11, wherein said seal being permanently disposed to said plate.
